(19) United States
(12) Patent Application Publication
(10) Pub. No.: US 2026/0111185 A1
(43) Pub. Date: Apr. 23, 2026

(54) CONVERSION OF UNSTRUCTURED DATA USING ARTIFICIAL INTELLIGENCE

(71) Applicant: American Express Travel Related Services Company, Inc., New York, NY (US)

(72) Inventors: Aniesh Chawla, Phoenix, AZ (US); Pedro Burglin Paes, Peoria, AZ (US); Srinivas Dasari, Scottsdale, AZ (US); Shoma Samir Chakravarty, Chevy Chase, MD (US)

(21) Appl. No.: 18/922,505

(22) Filed: Oct. 22, 2024

(51) Int. Cl. G06F 8/35

(52) U.S. Cl. CPC G06F 8/35

(57) ABSTRACT

Disclosed are various embodiments for automating the extraction and structuring of source code using machine learning. A computing device can obtain one or more lines of code from a code repository, where the one or more lines of code correspond to an application. The computing device can extract, with a machine learning model, functional data from the one or more lines of code. Then, the computing device can generate, with the machine learning model, a specification for the application based at least in part on the functional data. The specification can include at least a description of the code.

### BACKGROUND

Many organizations operate a variety of software applications, where each application has corresponding source code. The source code for these applications can be in many different programing languages and frameworks, and is often stored in code repositories managed by a source code management system. Source code in itself is a vast knowledge base. It can be difficult for an organization to extract this knowledge from source code due to the unstructured nature of source code, and the illegibility of the code to non-programmer readers.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2A and 2B are a flowchart illustrating one example of functionality implemented as portions of an application executed in a computing environment in the network environment of FIG. 1 according to various embodiments of the present disclosure.

FIG. 3 is a sequence diagram illustrating interactions between various components of the network environment of FIG. 1 according to various embodiments of the present disclosure.

### DETAILED DESCRIPTION

Disclosed are various approaches for automating architecture and data management at the source code level by using machine-learning and generative artificial intelligence to interpret source code and provide a structured, comprehensible output. Many organizations are subject to various internal and external regulations, reporting requirements, and other standards. It is often necessary for an organization to reevaluate enterprise-wide compliance as updates and changes are made to these regulations. However, for organizations with multiple software-based operations, it can be difficult to determine exactly which actions are performed in a specific software project as well as what data is used, how the actions are executed, which systems may be implicated, etc. Searching unstructured code repositories to answer these questions could require a team of skilled programmers to search the source code, interpret the source code, and search any and all implicated systems across an organization. Such a process would not only be very costly to an organization but would also be time-consuming and error-prone.

Accordingly, various embodiments of the present disclosure relate to automating the extraction and structuring of data from source code repositories using machine learning and generative artificial intelligence (AI). By using various forms of AI, the present invention can rapidly extract data from source code and generate a specification for each application or project. In addition, the present system can further interpret the specification to identify other systems and data which are referred to by the application or project. Once those systems have been identified, the present invention can generate contextual information and modify the specification to include the additional contextual information. These enhanced specifications can then be saved in a structured, easy-to-search database, thus allowing for rapid governance and management of an organization's entire code source repository. By automating the data interpretation, extraction, and compilation as well as the generation of structured data resources, the present invention converts a previously laborious and costly process to an almost-instantaneous and user-friendly experience. Numerous other benefits and advantages of the present disclosure are described throughout.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

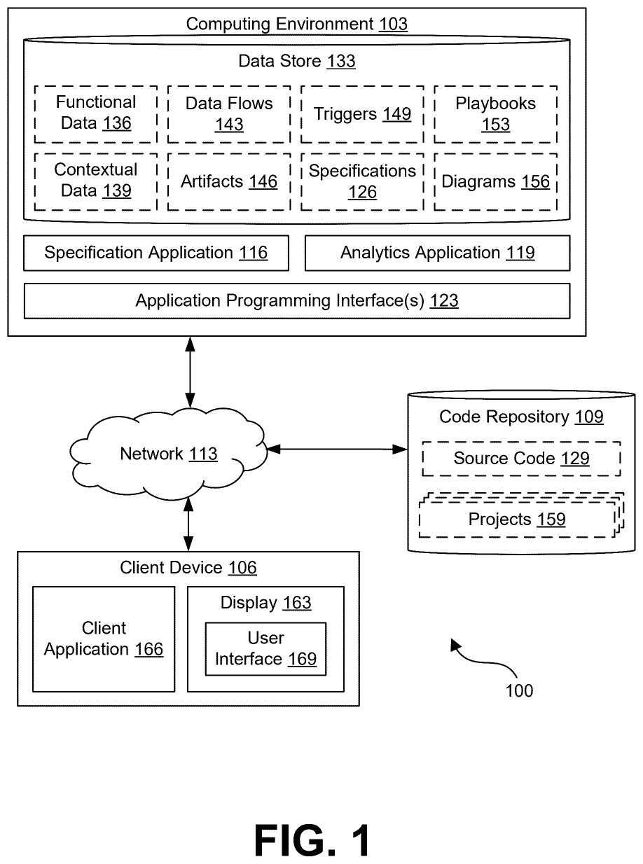

With reference to FIG. 1, shown is a network environment 100 according to various embodiments. The network environment 100 can include a computing environment 103, a client device 106, and a code repository 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a specification application 116, an analytics application 119, one or more application programming interfaces (APIs) 123, and other applications, services, processes, systems, engines, or functionality not discussed in detail herein.

The specification application 116 can be executed to generate a specification 126 based at least in part on one or more lines of source code 129. The specification application 116 can use artificial intelligence (AI) in the form of a machine learning model, a large language model (LLM), a generative AI technology (e.g., retrieval-augmented generation (RAG) technology, generative adversarial networks (GANs), variational autoencoders (VAEs), autoregressive models, recurrent neural networks (RNNs), transformer-based models, etc.), or other form of artificial intelligence (AI). With the help of these technologies, the specification application 116 can extract data from the lines of source code 129 to generate the specification 126, explaining what the source code 129 does and any interfaces or data which are exposed or consumed.

The analytics application 119 can be executed to conduct further processing and analytics on one or more saved specifications 126. The analytics application 119 can be representative of a downstream enterprise use case for handling the specifications 126 generated by the specification application 116. For example, the analytics application 119 can be a part of a system for architecture governance, data governance, data lifecycle management, data lineage, data journeys, etc. within an enterprise or organization. In some examples, the analytics application 119 can read and interpret specifications 126 in order to determine regulatory compliance for the underlying source code 129. The analytics application 119 can process multiple specifications 126 generated by the specification application 116 and perform enterprise-or organization-wide analyses of the source code 129.

The API(s) 123 can be executed to perform a various number of tasks. Each API 123 can be configured to provide an interface for other applications to interact with and/or make use of the functionality of the various applications within the network environment 100. For example, each API 123 can be configured to receive a request from another application in the network environment 100. In response to receiving a request, the API(s) 123 can introspect various properties of the request, including one or more IP addresses, status codes, tokens, or request header information. Additionally, the API(s) 123 can validate any of the data in the request. The API(s) 123 can define the kinds of function calls or requests that can be made by other applications, how to make them, the data formats that should be used, the conventions to follow, etc. When a function provided or exposed by the API(s) 123 is called, the applications can perform the operations specified by the called function and return the specified type of result. The API(s) 123 can do other various tasks that are not listed here, including processing data, authorizing transactions, directing data to be stored in a data store, or other various actions. This disclosure is not intended to limit the scope of the type of actions that the API(s) 123 can be executed to perform.

Also, various data can be stored in a data store 133 that is accessible to the computing environment 103. The data store 133 can be representative of a plurality of data stores 133, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 133 is associated with the operation of the various applications or functional entities described below. This data can include specifications 126, functional data 136, contextual data 139, data flows 143, artifacts 146, triggers 149, playbooks 153, diagrams 156, and potentially other data.

The specifications 126 can represent uniform and structured descriptions of a set of source code 129. A specification 126 can include information about a particular project 159, such as a service or application, which is associated with one or more lines of source code 129. The specification 126 can describe the function of the source code 129 using functional data 136 extracted from the source code 129. In addition, the specification 126 can be updated to include additional contextual data 139 about the specific calls, responses, databases, data, etc. used for the operation of the source code 129. In some examples, the specification 126 can be represented in a standardized format, such as JavaScript Object Notation (JSON) or a markup language (e.g., Extensible Markup Language (XML) or Yet Another Markup Language (YAML)).

The functional data 136 can represent information about the operation of the source code 129. For example, the functional data 136 can include all external interfaces (e.g., API(s) 123, functions, databases, etc.) with which the source code 129 interacts. For example, the specification 126 can specifically identify all interfaces the source code 129 is exposing along with all related data fields and all interfaces the source code 129 is consuming along with all related data fields and database structured query languages (SQLs), create read update and delete (CRUD) operations, etc. The functional data 136 can further include the application, platform, or domain in which the source code 129 operates, as well as file transfers, remote procedure calls (RPCs), and various other information about the operation of the source code 129.

The contextual data 139 can represent additional context about the operation of the source code 129 which is gleaned from the various systems across an entity or organization which are implicated in the operation of the source code 129. For example, the contextual data 139 can include information about various systems such as an API catalog for the organization, an application inventory, a database catalog, organization data models and taxonomy, and various other systems which may be utilized during the execution of the source code 129. In some examples, the contextual data 139 can include function catalog links, requests and responses, API catalog links, hypertext transfer protocol (HTTP) methods, logical data models, entity relationship diagrams, queries, tables, fields, and various other data to give context to the operation of the source code 129.

The data flows 143 can represent a chronological order of information exchange as determined by the source code 129. A data flow 143 can correspond to the flow of information across systems as initiated by the source code 129. For example, in some embodiments, a data flow 143 can include the various calls, requests, and responses between systems as well as the identities of those systems. In addition, a data flow 143 can include the types of data being transferred. In some embodiments, contextual data 139 can be extracted from or based at least in part on one or more data flows 143.

The artifacts 146 can represent a specification of information that is used or produced by a software development process or by deployment and operation of a system. For example, an artifact 146 can represent a model, a diagram, source code file, documentation (e.g., in the form of a file, web page, etc.), database tables, scripts, etc. Artifacts 146 can be generated from the specification 126, the functional data 136, the data flows 143, or directly from the source code 129.

The triggers 149 can represent an event, notification, message, request, or other prompt which would require an update to a specification 126. In some examples, an update to the source code for an application, service, or system can be a trigger 149. In another example, a trigger 149 can be a request sent from an analytics application 119, or other system, service, or application in the network environment 100. Each trigger 149 can include information about a particular project 159 or specific lines of source code 129 which require the specification 126 or update to the specification 126.

The playbooks 153 can represent a quick reference guide providing an overview of how an application or project 159 works. A playbook 153 can correspond to an individual project 159, an application, one or more lines of source code 129, or another system or service in the network environment 100. The playbook 153 can represent a collection of a software system's components, tools, modules, interfaces, data, libraries, and guides for how these interact during operation of the system. In some examples, the playbook 153 includes one or more artifacts 146.

The diagrams 156 can represent a graphical or visual representation of the operation of an application, system, service, or source code 129. In some examples, a diagram 156 can represent a flowchart or flow diagram which demonstrates the various steps performed in the execution of an application. The diagrams 156 can be generated based at least in part on the specification 126, the functional data 136, the source code 129, the artifacts 146, and potentially other data.

In addition, various data is stored in a code repository 109 that is accessible to the computing environment 103. The code repository 109 can be representative of a plurality of code repositories 109, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the code repository 109 is associated with the operation of the various applications or functional entities described below. This data can include source code 129, projects 159, and potentially other data.

The source code 129 can represent one or more lines of programming text which can be compiled into one or more executable computer programs. The source code 129 can represent a combination of source code 129 corresponding to various applications or projects 159. The source code 129 can be stored in the code repository 109 in any programming language.

The projects 159 can represent a plurality of systems, applications, services, or other form of functional software. In some examples, one project 159 encompasses one or more applications which work together to achieve one goal or function. Each project 159 can be associated with one or more sections of the source code 129.

The client device 106 is representative of a plurality of client devices that can be coupled to the network 113. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 163, such as liquid crystal displays (LCDs), gas plasma-based flat panel displays, organic light emitting diode (OLED) displays, electrophoretic ink (“E-ink”) displays, projectors, or other types of display devices. In some instances, the display 163 can be a component of the client device 106 or can be connected to the client device 106 through a wired or wireless connection.

The client device 106 can be configured to execute various applications such as a client application 166 or other applications. The client application 166 can be executed in a client device 106 to access network content served up by the computing environment 103 or other servers, thereby rendering a user interface 169 on the display 163. To this end, the client application 166 can include a browser, a dedicated application, or other executable, and the user interface 169 can include a network page, an application screen, or other user mechanism for obtaining user input. The client device 106 can be configured to execute applications beyond the client application 166 such as email applications, social networking applications, word processors, spreadsheets, or other applications.

Next, a general description of the operation of the various components of the network environment 100 is provided. To begin, an organization or enterprise can have one or more projects 159 which are useful for running the enterprise. Each of these projects 159 can have associated source code 129 which is responsible for allowing these projects 159 to function. In some examples, an enterprise architect can initiate the generation of a specification 126 for a project 159 by using a client application 166 to send a trigger 149 to a specification application 116. However, in another example, the specification application 116 can receive a trigger 149 based at least in part on an update to the source code 129, a directive from a management system, or other source.

Once the specification application 116 has received a trigger 149, the specification application 116 can identify the project 159 or source code 129 which needs a specification 126 and begin analyzing the source code 129 to extract various data. The specification application 116 can utilize a machine learning model, or generative AI, to analyze the various lines of source code 129 and produce a structured specification 126. The specification 126 can be a structured text document, converting the convoluted programming language of the source code 129 into an easily accessible summary of the actions performed and data transferred in the execution of the source code 129. In some examples, the specification application 116 can generate the specification 126 by first extracting functional data 136 and then extracting contextual data 139.

In order to extract the contextual data 139, the specification application 116 can communicate with various systems across the enterprise to develop a larger picture of the operation of the source code 129 at issue. The functional data 136 extracted from the source code 129 can serve as a roadmap, identifying the various other enterprise systems implicated in the execution of the source code 129. Thus, based at least in part on the functional data 136, the specification application 116 can extract information and context from those enterprise systems in the form of contextual data 139. The specification application 116 can generate or update a specification 126 based at least in part on the functional data 136 and the contextual data 139. Once the specification 126 has been generated, the specification application 116 can save the specification 126 in a data store 133 or send the specification 126 to an analytics application 119 for further processing.

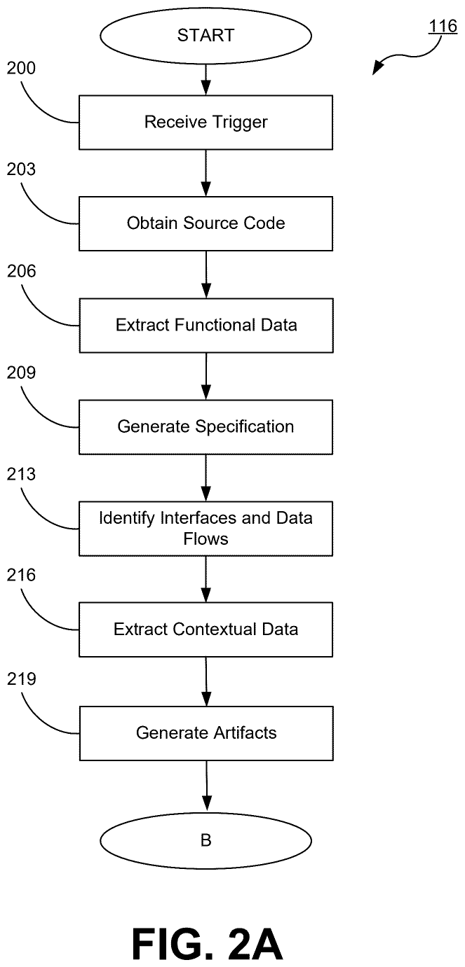

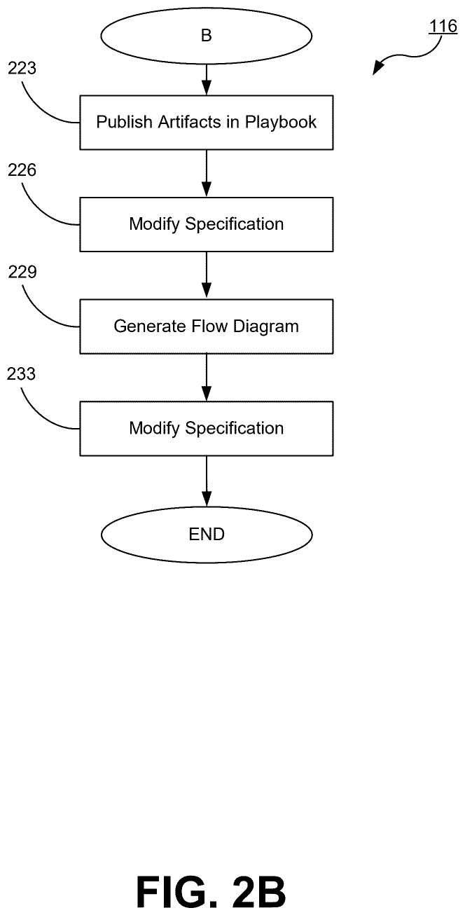

Referring next to FIGS. 2A and 2B, shown is a flowchart that provides one example of the operation of a portion of the specification application 116. The flowchart of FIGS. 2A and 2B provides merely an example of the many different types of functional arrangements that can be employed to implement the operation of the depicted portion of the specification application 116. As an alternative, the flowchart of FIGS. 2A and 2B can be viewed as depicting an example of elements of a method implemented within the network environment 100.

Beginning with block 200, the specification application 116 can be executed to receive a trigger 149. The specification application 116 can receive a trigger 149 which requests the generation of a specification 126 for a particular portion of source code 129, an application, a system, or another project 159. The trigger 149 can include information such as for which project 159 a specification 126 is needed, where to find the relevant source code 129, and in some examples, which information is needed in the specification 126 itself. In some examples, the specification application 116 can receive the trigger 149 from a client application 166, or other system, service, or application in the network environment 100.

Next, at block 203, the specification application 116 can be executed to obtain source code 129. After receiving the trigger 149 at block 200, the specification application 116 can determine which source code 129 is needed and where to obtain the source code 129 based at least in part on the trigger 149. In some examples, the specification application 116 can receive the source code 129 with the trigger 149 at block 200. However, in other examples, the specification application 116 can obtain the source code 129 from a code repository 109 or other system, service, or application in the network environment 100.

At block 206, the specification application 116 can be executed to extract functional data 136. In some examples, the specification application 116 can utilize a machine learning model to extract functional data 136 from the source code 129 obtained at block 203. In some examples, the specification application 116 can extract functional data 136 from one or more lines of source code 129 by parsing through each line of source code 129, determining the function or purpose of each line, and compiling the overall effect of the lines of source code 129 as functional data 136. The specification application 116 can save the functional data 136 in a data store 133.

Next, at block 209, the specification application 116 can generate a specification 126. In some embodiments, the specification application 116 can use the functional data 136 extracted at block 206 to generate the specification 126. The specification can generate the specification 126 based at least in part on the functional data 136, but in some examples, the specification 126 is generated based at least in part on the source code 129, the project 159, the trigger 149, or other data from the network environment 100.

At block 213, the specification application 116 can identify one or more interfaces and/or one or more data flows 143. The specification application 116 can identify one or more interfaces and/or one or more data flows 143 based at least in part on the specification 126 generated at block 209, the functional data 136 extracted at block 206, or the source code 129 obtained at block 203. In some examples, the specification application 116 identifies one or more application programming interfaces 123 which the source code 129 implicates in its execution. For example, the specification application 116 can use the functional data 136 to determine that the source code 129 makes a call to a particular API 123 to complete an operation. Similarly, in another example, based at least in part on the specification 126, the specification application 116 can identify a data flow 143 which demonstrates the journey of particular data as the source code 129 is executed.

At block 216, the specification application 116 can be executed to extract contextual data 139. The specification application 116 can extract contextual data 139 based at least in part on the one or more interfaces and/or one or more data flows 143 identified at block 213. For example, the specification application 116 can use a data flow 143 identified at block 213 to determine one or more databases which are implicated in the operation of the source code 129 and extract contextual data 139 from the one or more databases.

Next, at block 219, the specification application 116 can be executed to generate one or more artifacts 146. In some examples, the specification application 116 generates the one or more artifacts 146 based at least in part on the contextual data 139 extracted at block 216. The specification application 116 can generate one or more artifacts 146 based at least in part on the functional data 136, specification 126, or the interfaces and/or data flows 143. After block 219, the flowchart proceeds to FIG. 2B.

In block 223 of FIG. 2B, the specification application 116 can be executed to publish one or more artifacts 146 in a playbook 153. In some examples, the specification application 116 can publish the artifacts 146 from block 219 in an architecture playbook 153. If a playbook 153 for the relevant project 149 has not yet been generated, the specification application 116 can generate the playbook 153 based at least in part on the specification 126 from block 209 and publish the artifacts 146 in the playbook 153.

Next, at block 226, the specification application 116 can be executed to modify the specification 126. The specification application 116 can modify the specification 126 based at least in part on the contextual data 139 extracted at block 216, the artifacts 146 generated at block 219, or the interfaces and/or the data flows 143 identified at block 213. In some examples, the specification application 116 can modify the specification 126 to include the contextual data 139, the artifacts 146, and/or the interfaces and data flows 143 as well.

At block 229, the specification application 116 can be executed to generate a flow diagram 156. In some examples, the specification application 116 can generate a flow diagram 156 based at least in part on the modified specification 126 from block 226. The flow diagram 156 can be generated in response to the trigger 149 received at block 200, or in response to another request or prompt. In some examples, the specification application 116 can generate a flow diagram 156 based at least in part on the specification 126 generated at block 209. The flow diagram 156 can include functional data 136 from block 206, interfaces and/or data flows 143 from block 213, contextual data 139 from block 216, or artifacts from block 219.

At block 233, the specification application 116 can be executed to modify the specification 126. Similar to block 226, the specification application 116 can modify the specification 126 generated at block 209 to further include the flow diagram 156 from block 229. In some examples, the specification application 116 can be executed to modify the specification 126 any time new data is gathered. After block 233, the flowchart of FIGS. 2A and 2B comes to an end.

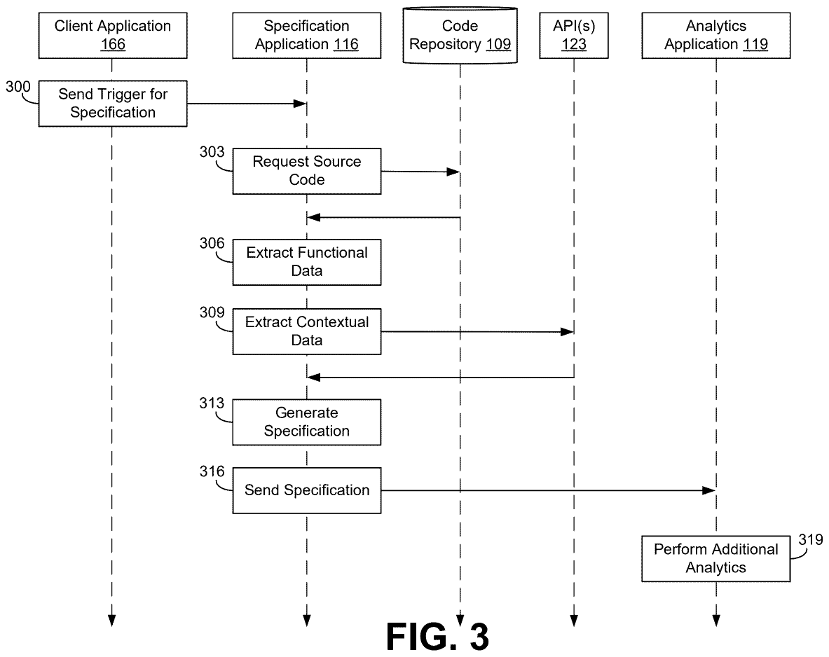

Moving next to FIG. 3, shown is a sequence diagram that provides one example of the interactions between the client application 166, the specification application 116, the analytics application 119, the code repository 109, and the API(s) 123. The sequence diagram of FIG. 3 provides merely an example of the many different types of potential interactions between the client application 166, the specification application 116, the analytics application 119, the code repository 109, and the API(s) 123. As an alternative, the sequence diagram of FIG. 3 can be viewed as depicting an example of elements of a method implemented within the network environment 100.

Beginning with block 300, the client application 166 can send a trigger 149 for a specification 126. The client application 166 can generate a trigger 149 in response to a user interaction with a user interface 169 on a client device 106. The trigger 149 can include which information should be included in the specification 126, which source code 129 the specification 126 should relate to, as well as various other information. The client application 166 can be executed to send the trigger 149 to a specification application 116 in order to initiate the generation of a specification 126.

At block 303, the specification application 116 can be executed to request the source code 129. In some examples, the specification application 116 can request the source code 129 based at least in part on the trigger 149 sent at block 300. In response to receiving the trigger 149, the specification application 116 can identify which source code 129 is needed for the specification 126, where the source code 129 is stored, and send a request to a code repository 109 for the source code 129. In some examples, the specification application 116 can request the source code 129 from a code repository 109. However, in some examples, the specification application 116 can request the source code 129 from another data store 133 or other source in the network environment 100.

At block 306, the specification application 116 can be executed to extract functional data 136 from the source code 129. As described at the discussion of block 206, the specification application 116 can utilize a machine learning model to extract functional data 136 from the source code 129 obtained at block 303. In some examples, the specification application 116 can extract functional data 136 from one or more lines of source code 129 by parsing through each line of source code 129, determining the function or purpose of each line, and compiling the overall effect of the lines of source code 129 as functional data 136. The specification application 116 can save the functional data 136 in a data store 133.

Next, at block 309, the specification application 116 can extract contextual data 139 from the source code 129. In some examples, the specification application 116 can use the functional data 136 extracted at block 306 as a roadmap to identify systems, data, or interfaces which are implicated in the execution of the source code 129. Then, the specification application 116 can extract contextual data 139 from each of the implicated systems and data. For example, the specification application 116 can identify one or more API(s) 123 based at least in part on the functional data 136 and communicate with the API(s) in order to extract contextual data 139. In another example, the specification application 116 can identify one or more databases implicated in the functional data 136 and request the data shared from the databases. In some examples, the specification application can save the contextual data 139 in a data store 133.

At block 313, the specification application 116 can be executed to generate a specification 126. The specification application 116 can use the functional data 136 extracted at block 306 and/or the contextual data 139 extracted at block 309 to generate the specification 126. In some examples, the specification application 116 can generate the specification 126 based at least in part on the trigger 149 from block 300.

Next, at block 316, the specification application 116 can be executed to send the specification 126. In some examples, the specification application 116 can determine a location for the specification 126 based at least in part on the trigger 149 received at block 300. Then, the specification application 116 can send the specification 126 to the location. For example, if the trigger 149 includes an instruction to use the specification 126 in further analytic processes, the specification application 116 can send the specification 126 to an analytics application 119 for further processing. In another example, if the trigger 149 includes an instruction to store the specification 126, the specification application 116 can send the specification 126 to a data store 133. In some examples, the specification application 116 can send the specification 126 to another location, system, or service in the network environment 100.

At block 319, the analytics application 119 can perform additional analytics. In some examples, the analytics application 119 can perform enterprise-wide analytics based at least in part on the specification 126 sent at block 316, along with many other specifications 126. In some examples, the analytics application 119 can perform additional analytics by searching for key terms in the specification 126, comparing multiple specifications 126, identifying particular data from the specification 126, or many other forms of analysis. After block 319, the sequence diagram of FIG. 3 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain one or more lines of code from a code repository, the one or more lines of code corresponding to an application;
extract, with a machine learning model, functional data from the one or more lines of code; and
generate, with the machine learning model, a specification for the application based at least in part on the functional data, the specification including at least a description of the code.

2. The system of claim 1, wherein the machine-readable instructions further cause the computing device to at least:
receive a trigger associated with the application; and
obtain the one or more lines of code in response to the trigger.

3. The system of claim 1, wherein the machine-readable instructions further cause the computing device to at least:
extract, with the machine learning model, contextual data from an application environment; and
modify, with the machine learning model, the specification based at least in part on the contextual data.

4. The system of claim 1, wherein the machine-readable instructions further cause the computing device to at least save the specification in association with the application in a data store.

5. The system of claim 1, wherein the machine-readable instructions further cause the computing device to at least:
generate one or more artifacts based at least in part on the functional data; and
modify the specification based at least in part on the one or more artifacts.

6. The system of claim 5, wherein the machine-readable instructions further cause the computing device to at least publish the one or more artifacts in an architecture playbook associated with the application.

7. The system of claim 1, wherein the machine-readable instructions further cause the computing device to at least generate a flow diagram based at least in part on the specification, the flow diagram corresponding to the application.

8. A method, comprising:
obtaining, by a computing device, one or more lines of code from a code repository, the one or more lines of code corresponding to an application;
extracting, with a machine learning model on the computing device, functional data from the one or more lines of code; and
generating, with the machine learning model, a specification for the application based at least in part on the functional data, the specification including at least a description of the code.

9. The method of claim 8, further comprising:
receiving, by the computing device, a trigger associated with the application; and
obtaining, by the computing device, the one or more lines of code in response to the trigger.

10. The method of claim 8, further comprising:
extracting, with the machine learning model, contextual data from an application environment; and
modifying, with the machine learning model, the specification based at least in part on the contextual data.

11. The method of claim 8, further comprising saving, by the computing device, the specification in association with the application in a data store.

12. The method of claim 8, further comprising:
generating, with the machine learning model, one or more artifacts based at least in part on the functional data; and
modifying, with the machine learning model, the specification based at least in part on the one or more artifacts.

13. The method of claim 12, further comprising publishing, with the machine learning model, the one or more artifacts in an architecture playbook associated with the application.

14. The method of claim 8, further comprising, generating, with the machine learning model, a flow diagram based at least in part on the specification, the flow diagram corresponding to the application.

15. A system, comprising:
a computing device comprising a processor and a memory;
a machine learning model stored in the memory; and
machine-readable instructions stored in the memory that, when executed by the processor, cause the computing device to at least:
extract, with the machine learning model, functional data from one or more lines of source code associated with a project;
identify, with the machine learning model, one or more programming interfaces based at least in part on the functional data;
extract, with the machine learning model, contextual data from the one or more programming interfaces; and
generate, with the machine learning model, a structured specification comprising at least the functional data and the contextual data.

16. The system of claim 15, wherein the machine-readable instructions, when executed by the processor, further cause the computing device to at least:
receive a trigger associated with the project; and
obtain the one or more lines of code in response to the trigger.

17. The system of claim 15, wherein the machine-readable instructions, when executed by the processor, further cause the computing device to at least:
generate one or more artifacts based at least in part on the functional data; and
modify the structured specification based at least in part on the one or more artifacts.

18. The system of claim 17, wherein the machine-readable instructions, when executed by the processor, further cause the computing device to at least publish, with the machine learning model, the one or more artifacts in an architecture playbook associated with the project.

19. The system of claim 15, wherein the machine-readable instructions, when executed by the processor, further cause the computing device to at least generate a flow diagram based at least in part on the structured specification, the flow diagram corresponding to the project.

20. The system of claim 15, wherein the machine-readable instructions, when executed by the processor, further cause the computing device to at least:
identify, with the machine learning model, one or more data flows based at least in part on the functional data;
extract, with the machine learning model, contextual data from the one or more data flows; and
modify the structured specification based at least in part on the one or more data flows.
